(19) United States
(12) Patent Application Publication
(10) Pub. No.: US 2007/0081798 A1
(43) Pub. Date: Apr. 12, 2007

(54) Player for optical disc and its play back method

(75) Inventors: Yang Peng, Shanghai (CN); He Dahua, Shangai (CN); Declan Patrick Kelly, Eindhoven (NL); Bei Wang, Shanghai (CN); Philip Steven Newton, Eindhoven (NL); Sheng Jin, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN, NETHERLAND (IL)

(21) Appl. No.: 10/578,376

(22) PCT Filed: Nov. 5, 2004
(86) PCT No.: PCT/IB04/52324

§ 371 Date: May 5, 2006

(30) Foreign Application Priority Data
Nov. 10, 2003 (CN) 200310116102.1

(51) Int. Cl. H04N 5/91

(52) U.S. Cl. 386/126; 386/46

(57) ABSTRACT

An optical disc player includes a detecting module and a creating module. The detecting module is used to detect whether to meet a branch point or an interruption point or a pause point; and the creating module is used to create a corresponding bookmark as a navigation for the subsequent broadcast to record the relevant information of a branch point or an interruption point or a pause point when meeting the branch point or the interruption point or the pause point. The playing method of the player includes: detecting whether to meet a branch point or an interruption point or a pause point, creating a corresponding bookmark as a navigation for the subsequent broadcast to record the relevant information of the branch point or the interruption point or the pause point when to meet the branch point or the interruption point or the pause point.

### FIELD OF THE INVENTION

The present invention relates to a kind of player and the playing method thereof, particularly to a kind of optical disc player and the playing method thereof.

### BACKGROUND OF THE INVENTION

With the development of optical storage technology and the playing technology, more and more content suppliers of optical disc, when making the content of optical disc, store the same content in multi-branches for the user to choose, thus provide different entertainment and purposes for different users in an optical disc with the same content(the same movie or the same tutorial for learning). For example, a movie may be made with several ends, thus can be played in several branches for the user to choose, and each branch leads to a different end of the movie, so that the user can see different ends of the same movie in different branches according to their own preferences. Additionally, for example, the tutorial for learning may be edited into different branches for the user to choose according to their levels, so that the users can choose the branch leading to the level needed to learn according to their levels and preferences. Usually, the optical disc used to store content with different branches as mentioned above includes Blue-ray Disc, enhanced DVD (eDVD), etc.

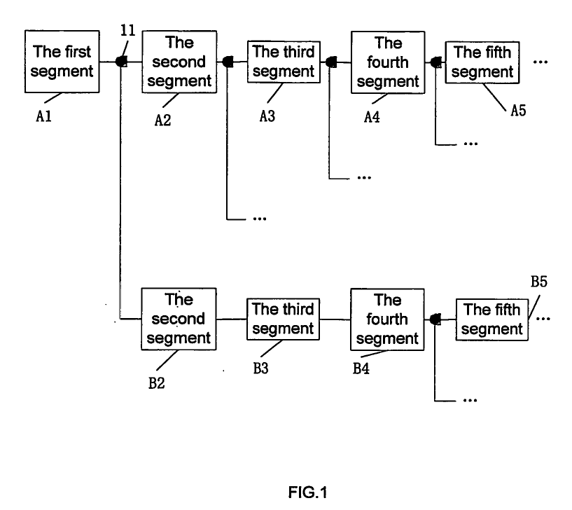

As shown in FIG. 1, the content of the optical disc is divided into several segments and stored in the optical disc. When playing the optical disc along the branches of “the first segment A1—the second segment A2—the third segment A3 —the fourth segment A4—the fifth segment A5” (referred to as “Branch A”), the user will see the whole scenario and corresponding end of the movie (e.g. the content of optical disc is movie). Further, the user can also choose other branches to see the complete content and different ends of such movie based on their demands. For instance, when playing the optical disc along the branch of “the first segment A1—the second segment B2—the third segment B3—the fourth segment B4—the fifth segment B5” (referred to as “Branch B”), the user will see another end of the movie. As can be seen from the two different branches for playing the optical disc, the branch point 11 is formed when the first segment A1 is diverged into the second segment A2 and the second segment B2. Of course, FIG. 1 also shows other branches and branch points in playing the content of optical disc, which are not described in detail here because the optical disc with such branch configuration is a kind of existing technology. In addition, the above described is only the logic structure of the optical disc, but the minimum unit of the real content of optical disc is countless Clip Files (or code stream). From the viewpoint of logic structure, each segment of the logic structure may correspond to many Clip Files, and different logic segments may also correspond to the same Clip File. While meeting the branch point 11 during playing the above optical disc, the player will display optional information on the screen and prompt the user to decide how to play. The user can choose the branch according to his demand, and choose the desirable scenario, end or level to see the content of optical disc, which improves the user's interest in seeing the optical disc and enhances the recreation.

When meeting the branch point 11 in playing optical disc, the player mentioned above will prompt the user to choose a branch on the screen to play the optical disc. However, there may be some special playing modes in the playing process, such as interruption of playing, pause of playing, fast-forwarding and fast-rewinding, and the player can not prompt the user to make a choice when meeting branch points in such special modes.

For example, when the playing is interrupted or paused, and the playing is stopped at the third segment A3 of Branch A, the player knows that it was stopped at the third segment of logic position when resuming playing optical disc, but the code stream corresponding to the third segment may possibly point to the third segment (even the fourth segment or the fifth segment) of other branches, namely, it may point to the third segment A3 of Branch A or the third segment B3 of Branch B. Therefore, only the pre-set playing value should be used to determine to resume playing at the third segment of which branch. It will be good if the pre-set value is the third segment A3 of Branch A; if the pre-set value is not the third segment A3 of Branch A, it will affect the user's interest in seeing the content of optical disc, because what the user sees before and after the movie is stopped do not correlate with each other at all, and the end is also not what the user expects.

On the contrary, with the increasing capacity of optical disc and the increasing interactivity between the user and the content of optical disc, movies, TV play series, games and learning tutorials of tens of hours or even longer can be stored in single optical disc, so that the user will always finish reading the content of the optical disc after interruption or pause for several times. It is troublesome for the user if he can not find the position where the previous playing was stopped, and this will also greatly affect the user's interest in reading the content of the optical disc. If this is the case, it will be better to directly play linearly to the end point of the content of optical disc without any divergent structure.

The interruption and pause of playing will also occur for finding the original position or finding the playing point the user needs to reach by fast-forwarding or fast-rewinding. For example, while the user wants to fast-rewind from the fourth segment of Branch A to the second segment A2 of Branch A, it is likely to be fast-rewound to the second segment B2 of Branch B, which is obviously not expected by the user and will affect the user's interest in viewing.

As can be seen from those mentioned earlier, when the player is playing an optical disc with divergent structure, the advantages of divergent structure can not be well manifested at resumption of playing after being interrupted or paused as well as in the process of fast-forwarding or fast-rewinding. Instead, much inconvenience is presented thus it will severely affect the user's interest in viewing the content of optical disc.

Therefore, an improved player and the playing method thereof are needed, in which the drawbacks mentioned above are avoided.

### DISCLOSURE OF THE INVENTION

According to the present invention, there is provided a player which can automatically create bookmark at the interruption point, pause point and branch point.

Further, according to the present invention, there is provided a playing method which can automatically create bookmark at the interruption point, pause point and branch point.

The playing method described in the invention includes: detecting whether meeting a branch point of the playing content, and creating a corresponding bookmark, when meeting a branch point of the playing content, to record related information of said branch point for navigation of the subsequent playing.

The playing method described in the invention includes: detecting whether meeting an interruption or pause of the playing, and creating a corresponding bookmark, when meeting an interruption or pause of the playing, to record related information of such interruption point or pause point for navigation of the subsequent resumption of playing.

The player according to the invention includes a detecting device and a creating device. Wherein, the detecting device is used to detect whether meeting a branch point of the playing content, and the creating device is used to create a corresponding bookmark when meeting a branch point, and record related information of such branch point for navigation of the subsequent playing.

The player according to the invention includes a detecting device and a creating device. Wherein, the detecting device is used to detect whether meeting an interruption or pause of the playing, and the creating device is used to create a corresponding bookmark when meeting an interruption or pause, and record related information of such interruption point or pause point for navigation of the resumption of playing. In the present invention, the player creates bookmarks to record a plurality of information at each branch point and interruption/pause point in playing the optical disc, so that when the player is playing optical disc, no matter which state the player stays in, the positions where to start resuming the playing can be reached or found according to the information provided by the bookmark, thus the complete playing is achieved.

Other aims and achievements of the present invention and the complete understanding of the invention will become much clearer and more apparent by the following description with reference to the attached drawings and claims.

### BRIEF DESCRIPTION OF THE DRAWINGS

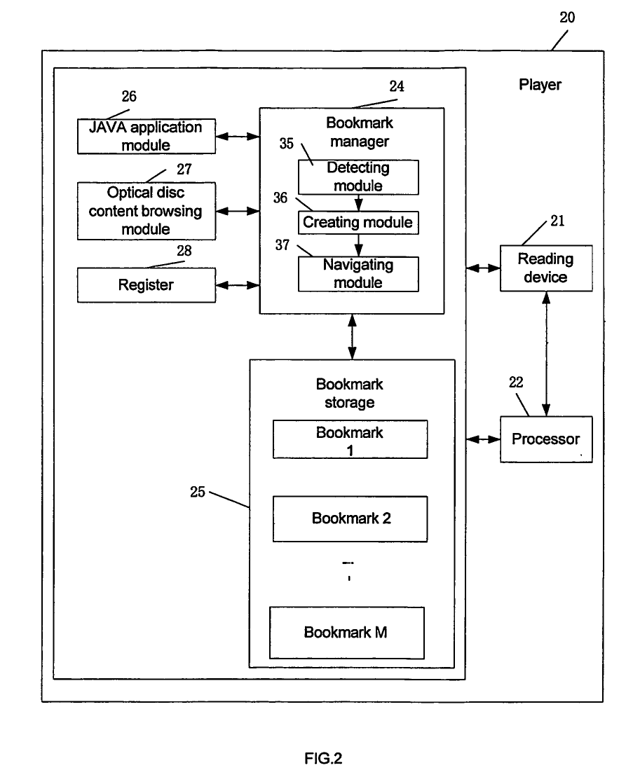

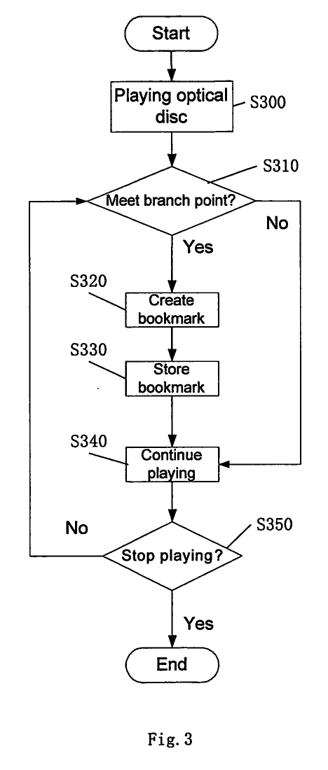

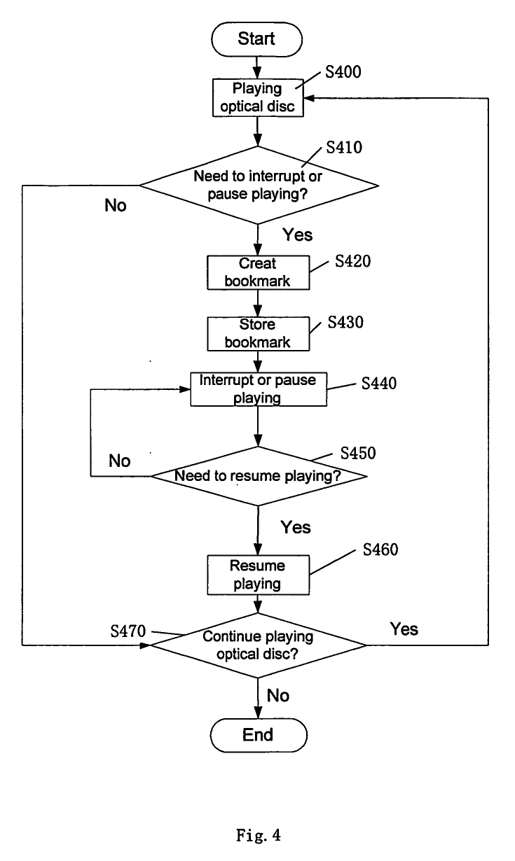

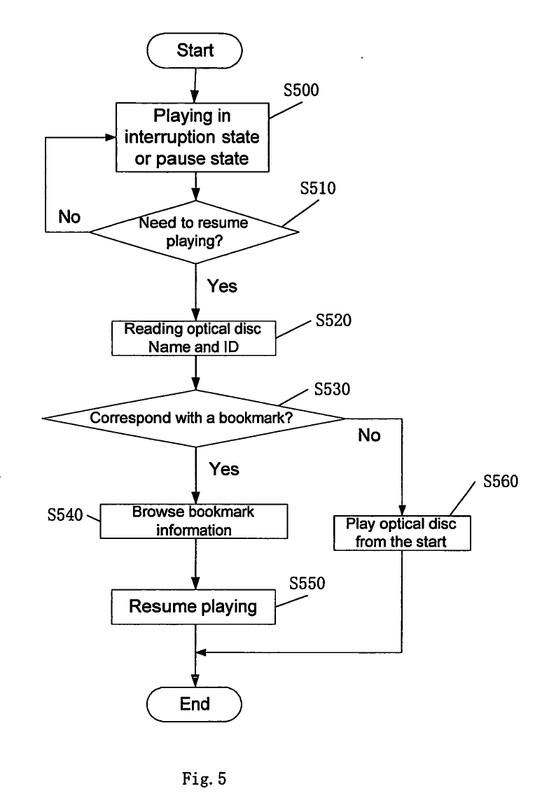

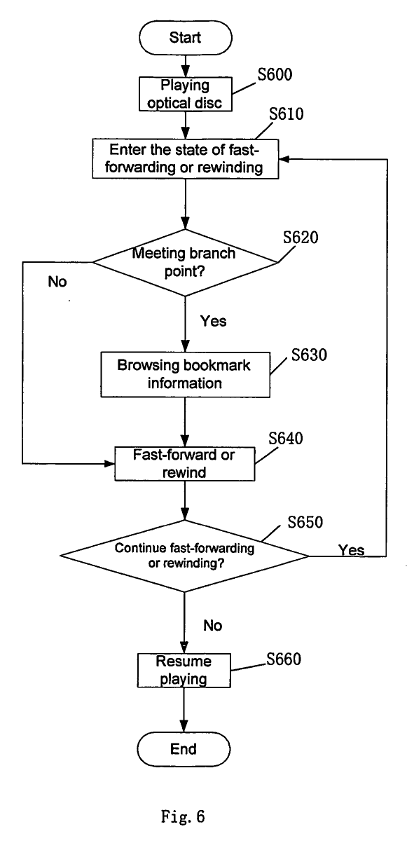

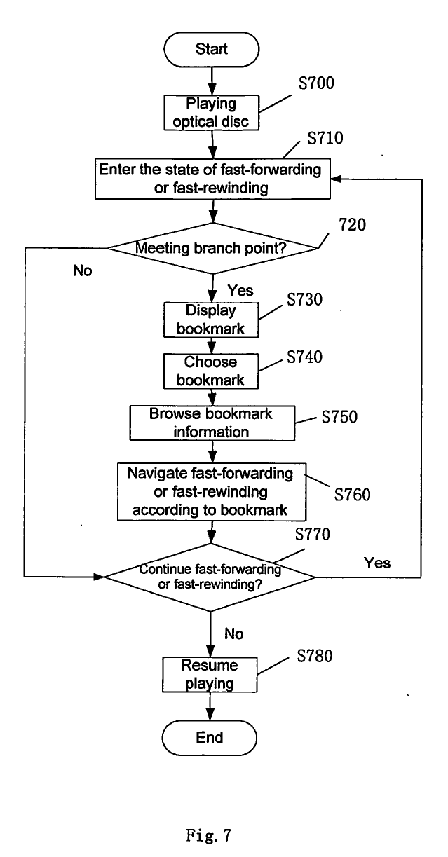

The present invention will now be described in detail by means of example and with reference to the attached schematic drawings, wherein: FIG. 1 shows a schematic drawing of the structure of existing optical disc content; FIG. 2 shows a schematic drawing of the structure of a player according to an embodiment of the invention; FIG. 3 shows a playing flow chart of an embodiment according to the invention when meeting a branch point in playing optical disc; FIG. 4 shows a playing flow chart of an embodiment according to the invention when meeting an interruption point or a pause point in playing optical disc; FIG. 5 shows a playing flow chart of an embodiment according to the invention when resuming from an interruption state or a pause state in playing optical disc; FIG. 6 shows a playing flow chart of an embodiment according to the invention when fast-forwarding or fast-rewinding in playing optical disc; FIG. 7 shows a playing flow chart of another embodiment according to the invention when fast-forwarding or fast-rewinding in playing optical disc.

In all the above drawings, like numbers refer to like or corresponding features and functions.

### PREFERRED EMBODIMENTS OF THE INVENTION

FIG. 2 shows the schematic structure of player 20 disclosed in an embodiment according the present invention. Player 20 comprises reading device 21, processor 22, bookmark manager 24, bookmark storage 25, JAVA application module 26 (application modules of other programmable language is also applicable), optical disc content browsing module 27 and register 28. Wherein, reading device 21 is connected with other elements and used to read the content of the optical disc (not shown here). Processor 22 is used to control the working process of reading device 21 and other elements. Bookmark manager 24 is connected with bookmark storage 25, JAVA application module 26, optical disc content browsing module 27 and register 28, respectively.

Bookmark manager 24 comprises detecting module 35, creating module 36 and navigating module 37. Wherein, detecting module 25 is used to detect whether player 20 meets branch points (shown as branch point 11 in FIG. 1), interruption or pause in playing the optical disc, and send a command of creating bookmark to creating module 36 when meeting such status. Creating module 36 is used to record related information of the branch points, interruption points or pause points, and store the recorded information into bookmark storage 25 to form bookmark (to be described in detail in the following). Navigating module 37 is used to browse the content of bookmark, and make use of such content for the navigation of playing process (such as interruption, pause, fast-forwarding or fast-rewinding).

The relevant information recorded by creating module 36 for forming bookmark includes information from optical disc content browsing module 27, e.g. optical disc ID and name, optical disc content name, play list ID and name, play item ID and name, clip file (or code stream file), clip file time offset (at the time position of clip file), network link information (URL), information in buffer (now shown here) and the information preloaded and stored in player 20.

Further, the relevant information for forming bookmark includes information from register 28 (including General Purpose Registers (GPRs) and Player Parameter Registers (PSRs)), e.g. user operational parameters (some commands input by the user, such as those to choose which branch to play the optical disc), neighboring fore-and-aft position parameters, creation time of this bookmark, language to express the audio/subtitle and content classification related information (content classification refers to that the chosen content in playing optical disc is suitable or not for young persons), sequenced JAVA application information from JAVA application module 26 (application information in C language or other programmable languages is also applicable), and possible link information among different bookmarks.

The above-mentioned link information among bookmarks refers to the linking information between a bookmark and its preceding/subsequent bookmark (parent/child bookmark). When there are many bookmarks, there will be many links accordingly, so that logic tree structure or chain structure will be formed among the bookmarks, and stay in special playing modes (e.g. interruption, pause, fast-forwarding, or fast-rewinding).

Bookmark storage 25 is used to store the bookmark transferred from creating module 36 of bookmark manager 24, and the stored bookmark includes one or more bookmarks representing bookmarks of different branch points, interruption points or pause points, or representing different bookmarks of the same branch point, interruption point or pause point (created at different time), such as bookmark 1, bookmark 2 . . . bookmark M, etc shown in FIG. 2.

In the process of playing optical disc, the player may temporarily store the bookmark of each branch point in bookmark storage 25, and make them disappear after stopping playing optical disc to save memory. Also, the player may firmly store the bookmark in bookmark storage 25 and leave it for the user to decide whether to clear the bookmark. However, the bookmark created when interrupted or paused is firmly stored in bookmark storage 25 and left for the user to decide whether to clear the bookmark.

According to the present invention, there are two methods for creating above-mentioned bookmark, the first one is to create corresponding bookmark when meeting branch point in the playing process, and the other one is to create corresponding bookmark when the playing is interrupted or paused. Both methods will be illustrated in the following.

FIG. 3 shows a playing flow chart of player 20 when meeting branch point in playing optical disc. In playing optical disc (Step S300), player 20 will detect whether meeting a branch point (Step S310), and will continue playing optical disc when no branch point is met (Step S340), or create a bookmark when meeting branch point (Step S320) and the bookmark contains the information described hereinbefore.

Subsequently, the player will store the created bookmark (Step S330) and continue playing optical disc (Step S340). Then it should be decided whether to stop playing (Step S350), and the playing process is ended if stopping playing, otherwise the player will return to detect whether meeting a branch point (Step S310) and repeat the foregoing processes.

FIG. 4 shows a playing flow chart of the player when interrupted or paused in playing optical disc. In playing optical disc (Step S400), the player will detect whether the playing is desirable to be interrupted or paused (Step S410), and will continue playing optical disc when it is undesirable (Step S470), and perform the steps described hereinafter (see the detailed descriptions below); or create a bookmark at the interrupted or paused position when it is desirable to be interrupted or paused (Step S420), then store the bookmark containing all information described hereinbefore in a bookmark storage 25 (Step S430), and finally interrupt or pause playing optical disc (Step S440).

In the foregoing process of interruption or pause (Step S440), the player will decide whether it is desirable to resume playing (Step S450), and when it is undesirable, the player will hold the interruption state or pause state (Step S440); when it is desirable, the player will resume playing, and the resumption process is based on the instruction of bookmark after navigating module browsing the stored bookmark (to be described at length in the following) (Step S460), wherein the bookmark used for navigation may be a bookmark created at the interruption point or pause point (additionally, all bookmarks concerned with the interruption point or pause point can be displayed on the screen, thus enabling the user to choose the desirable bookmark for navigation).

After resuming playing by the method mentioned above, the player will detect again whether it is desirable to continue playing optical disc (the foregoing Step S410 will go directly to such decision process when it makes sure that no interruption or pause is desirable) (Step 470), and end playing directly if it is undesirable to continue playing. When it is desirable to continue playing optical disc, the player will return to play optical disc (Step S400), and repeat the foregoing steps.

FIG. 5 shows a playing flow chart of player 20 when resuming from a pause state or an interruption state, and also presents a more detailed process of resuming playing (shown as Step S460 in FIG. 4).

While in the state of interruption or pause in playing optical disc (Step S500), it is up to the user's decision whether to resume playing optical disc (Step S510).

If it is undesirable to resume to playing state from the interruption state or pause state, the player will continue to hold the interruption state or pause state (Step S500). When it is desirable to resume the playing state, the player will read the optical disc name or ID (Step S520), and browse bookmark storage 25 (shown in FIG. 2) according to the read optical disc name or ID and find out whether it stores the bookmark containing the corresponding optical disc name or ID (Step S530).

If there is no bookmark corresponding to the read optical disc ID, it indicates that the optical disc is not the one which has stored bookmark before the playing is interrupted or paused, and the player will play the optical disc from the start (Step S560); certainly, the player can also directly give up playing.

If there is bookmark corresponding to the read optical disc name or ID, the player will browse all the information in such bookmark (Step S540) with navigating module 37 (shown in FIG. 2), and use the information in the bookmark browsed by navigating module 37 for navigation of resuming playing the corresponding content of the optical disc (Step S550), e.g. resuming the original audio, video, subtitle, language variety and sequenced JAVA application, etc. from interruption point or pause point, wherein the bookmark used for navigation may be a bookmark created at the interruption point or pause point (additionally, all bookmarks concerned with the interruption point or pause point can be displayed on the screen, thus enabling the user to choose the desirable bookmark for navigation).

Besides the interruption state or pause state, there still exists fast-forwarding and fast-rewinding states in playing optical disc. In fast-forwarding and fast-rewinding states, it is also necessary to make use of the bookmark created above in order to find the location to reach in playing optical disc with divergent branches.

FIG. 6 shows a flow chart of Player 20 when in fast-forwarding state or fast-rewinding state in playing optical disc, further, the following processes proceed after the bookmark is created (shown in FIG. 3). The player starts to play the optical disc (Step S600), and then enters fast-forwarding state or fast-rewinding state according to the user's demand (Step S610).

In fast-forwarding state or fast-rewinding state, the player will detect whether meeting a branch point during fast-forwarding or fast-rewinding (Step S620), and continue fast-forwarding or fast-rewinding when meeting no branch point (Step S640), and the choice is presented for the user to decide whether to stop fast-forwarding or fast-rewinding (Step S650).

When meeting a branch point, navigating module 37 (shown in FIG. 2) will browse the information of the bookmark at the branch point (Step S630), and use the information provided by the bookmark for navigation to choose the specific branch to fast-forward or fast-rewind, wherein the bookmark used for navigation may be a bookmark created at the branch point (additionally, all bookmarks concerned with such branch point can be displayed on the screen, thus enabling the user to choose the desirable bookmark for navigation) (Step S640), and again the choice is presented for the user to decide whether to stop fast-forward or fast-rewind (Step S650).

When the user does not need to continue fast-forwarding or fast-rewinding, then the playing is resumed from the location where fast-forwarding or fast-rewinding reaches (Step S660). When the user needs to continue fast-forwarding or fast-rewinding, then the playing is returned to fast-forwarding state or fast-rewinding state (Step S610) and the foregoing steps are repeated.

FIG. 7 shows a flow chart of the playing method of another embodiment when fast-forwarding or fast-rewinding in playing optical disc, the user, in the embodiment, can choose to fast-forward or fast-rewind according to the playing location to reach, and said process proceeds after the bookmark is created (shown in FIG. 3). Play optical disc (Step S700), and enter fast-forwarding state or fast-rewinding state according to the user's demand (Step S710), and the destination (address) that the fast-forwarding or fast-rewinding is to reach is determined by the user's input. The player will detect whether meeting a branch point (Step S720), and when no branch point is met, the choice is presented for the user to decide whether to continue fast-forwarding or fast-rewinding (Step S770).

When a branch point is met after the foregoing detection, all bookmarks concerned with such branch point are displayed (Step S730). The user will choose the desirable bookmark (Step S740), and navigating module 37 will browse the information of the bookmark chosen by the user (Step S750) and use the browsed bookmark information for navigation to choose the specific branch for fast-forwarding or fast-rewinding (Step S760), and the choice is presented for the user to decide whether to stop fast-forward or fast-rewind (Step S770).

When the user does not need to continue fast-forwarding or fast-rewinding, then playing optical disc is resumed (Step S780); when the user needs to continue fast-forwarding or fast-rewinding, then the playing is returned to continue fast-forwarding or fast-rewinding (Step S710) and the foregoing steps are repeated.

The player described above, when starting to play optical disc, can also create bookmarks automatically at all the branch points of the optical disc, which provides convenience for fast-forwarding or fast-rewinding in playing optical disc.

In playing the optical disc, the player according to the present invention creates bookmarks at each branch point and interruption/pause point to record corresponding information, so that the player, no matter in which state it stays, can reach or find the location to resume playing according to the information provided by the bookmarks and realize the complete playing.

While the present invention has been described with reference to the particular embodiments, various substitutions, modifications and changes may be apparent for those skilled in the art. Therefore, the present invention includes all such substitutions, modifications and changes within the spirit and scope defined by the following claims.

1. A method for playing optical disc, comprising the steps of:
detecting whether to meet a branch point within the playing contents; and
creating a corresponding bookmark, when meeting a branch point of the playing content, to record relevant information of said branch point for navigation of the subsequent playing.

2. The method for playing optical disc according to claim 1, further including:
fast-forwarding or fast-rewinding;
browsing a bookmark of a branch point if meeting the branch point during fast-forwarding or fast-rewinding; and selecting a specific branch to fast-forward or fast-rewind according to the information of the bookmark as the navigation.

3. The method for playing optical disc according to claim 1, further comprises showing the bookmark corresponding to a branch point when meeting the branch point to provide user with a choice.

4. A method for playing optical disc, comprising the steps of:
detecting whether to meet an interruption or pause; and
creating a corresponding bookmark, when meeting an interruption or pause of the playing, to record relevant information of such interruption point or pause point for navigation of the subsequent resumption of playing.

5. The method for playing optical disc according to claim 4, wherein the information stored in the bookmark includes at least one of the two, a name or an ID of the optical disc.

6. The method for playing optical disc according to claim 5, further comprises resuming the playing from the interruption or pause point, and reading out at least one of the two, a name or an ID of the optical disc which needs the resumption of the playing.

7. The method for playing optical disc according to claim 6, further comprises:
browsing the information of the bookmark if it is detected out that the information stored in the bookmark contains the name or ID of the optical disc which is read out; and
selecting a specific branch to fast-forward or fast-rewind using the information of the bookmark as a navigation.

8. An optical disc player, comprising:
a detecting module for detecting whether to meet a branch point within the playing contents or not; and
a creating module is used to create a corresponding bookmark when meeting a branch point, and record relevant information of such branch point for navigation of the subsequent playing.

9. The optical disc player according to claim 8, further comprises:
a navigating module, which is used to browse the content of bookmark, and make use of such content for the navigation of playing process

10. The optical disc player according to claim 8, wherein the bookmark comprises the relevant information of the branch point.

11. The optical disc player according to claim 8, further comprises a bookmark storage for storing the bookmarks.

12. The optical disc player according to claim 8, wherein each bookmark of each branch point comprises a link pointing to the previous bookmark and a link pointing to the next bookmark.

13. An optical disc player, comprising:
a detecting module for detecting whether to meet an interruption or pause; and
a creating module for creating a corresponding bookmark as a navigation for the resumption of the play to record the relevant information of the interruption point or pause point when meeting an interruption or a pause.

14. The optical disc player according to claim 13, further comprises a navigating module for browsing the bookmark and selecting a specific branch using the information of the bookmark as a navigation.

15. The optical disc player according to claim 13, wherein the bookmark comprises the relevant information of the interruption point or the pause point.

16. The optical disc player according to claim 13, further comprises a bookmark storage for storing the bookmarks.
